(19) United States
(12) Patent Application Publication
(10) Pub. No.: US 2008/0020320 A1
(43) Pub. Date: Jan. 24, 2008

(54) Color forming composition containing optional sensitizer

(76) Inventors: Cari L. Dorsh, Corvallis, OR (US); Vladek Kasperchik, Corvallis, OR (US); Mehrgan Khavari, Vorvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/490,568

(22) Filed: Jul. 20, 2006

(51) Int. Cl. G03C 1/00

(52) U.S. Cl. 430/270.1

(57) ABSTRACT

A method of forming a radiation imageable coating includes preparing a radiation-curable polymer matrix including an acidic activator species, forming a leuco-dye phase, distributing the leuco-dye phase in the polymer matrix, evaluating a power level of an targeted radiation source, and if the power level of the targeted radiation source is less than approximately 1 watt/cm², sensitizing the radiation imageable coating with a sensitizing agent corresponding to the targeted radiation source.

### BACKGROUND

Compositions that produce a color change upon exposure to energy in the form of light or heat are of great interest in generating images on a variety of substrates. For example, data storage media provide a convenient way to store large amounts of data in stable and mobile formats. For example, optical discs, such as compact discs (CDs), digital video discs (DVDs), or other discs allow a user to store relatively large amounts of data on a single relatively small medium. Traditionally, commercial labels were frequently printed onto optical discs by way of screen printing or other similar methods to aid in identification of the contents of the disc. Additionally, other substrates are often labeled with commercial labels that are either printed directly on the substrate or pre-formed on adhesive labels. However, with the various substrates that may be used as labels or otherwise receive markings, environmental conditions and marking speeds vary widely.

### SUMMARY

A method of forming a radiation imageable coating includes preparing a radiation-curable polymer matrix including an acidic activator species, forming a leuco-dye phase, distributing the leuco-dye phase in the polymer matrix, evaluating a power level of a targeted radiation source, and if the power level of the targeted radiation source is less than approximately 1 watt/cm², sensitizing the radiation imageable coating with a sensitizing agent corresponding to the targeted radiation source.

Additionally, a radiation imageable coating configured for use with a radiation source having a known power level includes a first phase including a radiation curable polymer matrix and an activator disposed in the radiation curable polymer matrix, a second phase insolubly distributed in the first phase, the second phase including a color-former, and if the known power level is less than approximately 1 watt/cm², a sensitizing agent distributed in at least one of the first and second phase.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the disclosure.

FIG. 1 illustrates a schematic view of a media processing system according to one exemplary embodiment.

FIG. 2 is a flowchart illustrating a method of forming an imageable composition according to one exemplary embodiment.

FIG. 3 is a flowchart illustrating a method for forming a radiation imageable composition, according to one exemplary embodiment.

FIG. 4 is a flow chart illustrating a method for forming a radiation imageable composition, according to one exemplary embodiment.

FIG. 5 is a flow chart illustrating a method for forming an image on a radiation imageable coating, according to one exemplary embodiment.

Throughout the drawings, identical reference numbers designate similar, but not necessarily identical, elements.

### DETAILED DESCRIPTION

The present exemplary systems and methods provide for the preparation of a two-phase radiation imageable thermochromic coating with an optional sensitizer to match the sensitivity of the coating to an available radiation source. In particular, a radiation-curable radiation imageable coating is described herein that can have a varied sensitivity to match an irradiation power of a contemplated radiation source. Further details of the present coating, as well as exemplary methods for forming the coatings on a desired substrate will be described in further detail below.

As used in the present specification, and in the appended claims, the term “radiation imageable discs” is meant to be understood broadly as including, but in no way limited to, audio, video, multi-media, and/or software discs that are machine readable in a CD and/or DVD drive, or the like. Non-limiting examples of radiation imageable disc formats include, writeable, recordable, and rewriteable discs such as DVD, DVD-R, DVD-RW, DVD+R, DVD+RW, DVD-RAM, CD, CD-ROM, CD-R, CD-RW, and the like.

For purposes of the present exemplary systems and methods, the term “color” or “colored” refers to absorbance and reflectance properties that are preferably visible, including properties that result in black, white, or traditional color appearance. In other words, the terms “color” or “colored” includes black, white, and traditional colors, as well as other visual properties, e.g., pearlescence, reflectivity, translucence, transparency, etc.

In the following description, for purposes of explanation, numerous specific details are set forth in order to provide a thorough understanding of the present systems and methods for forming a two-phase radiation imageable coating with an optional sensitizer to correspond the wavelength sensitivity of the coating to a known radiation source. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

### Exemplary Structure

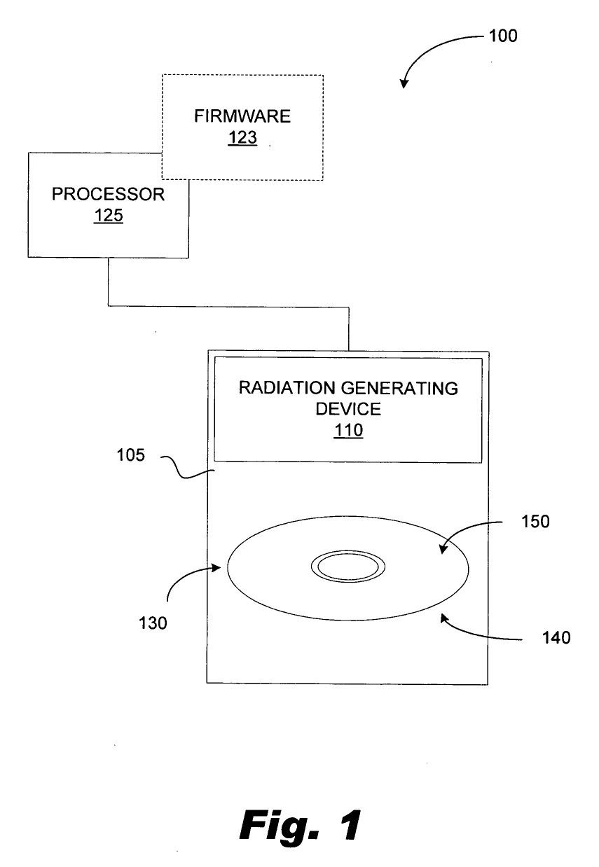

FIG. 1 illustrates a schematic view of a media processing system (100), according to one exemplary embodiment. As will be described in more detail below, the illustrated media processing system (100) may expose a radiation imageable surface with coatings of the present exemplary compositions, register an image on the coatings, and use the imaged object for a variety of purposes. For example, according to one exemplary embodiment, a radiation imageable data storage medium (radiation imageable disc) may be inserted into the media processing system (100) to have data stored and/or a graphic image formed thereon. As used herein, for ease of explanation only, the present dual band radiation imageable thermochromic coating will be described in the context of coating an optical disc such as a compact disc (CD) or a digital video disc (DVD). However, it will be understood that the present dual band radiation imageable thermochromic coating may be applied to any number of desired substrates including, but in no way limited to, polymers, papers, metal, glass, ceramics, and the like.

As illustrated in FIG. 1, the media processing system (100) includes a housing (105) that houses a radiation generating device (110), which may be controllably coupled to a processor (125). The operation of the radiation generating device (110) may be controlled by the processor (125) and firmware (123) configured to selectively direct the operation of the radiation generating device. The exemplary media processing system (100) also includes hardware (not shown), such as spindles, motors, and the like, for placing a radiation imageable disc (130) in optical communication with the radiation generating device (110). The operation of the hardware (not shown) may also be controlled by firmware (123) accessible by the processor (125). The above-mentioned components will be described in further detail below.

As illustrated in FIG. 1, the media processing system (100) includes a processor (125) having firmware (123) associated therewith. As shown, the processor (125) and firmware (123) are shown communicatively coupled to the radiation generating device (110), according to one exemplary embodiment. Exemplary processors (125) that may be associated with the present media processing system (100) may include, without limitation, a personal computer (PC), a personal digital assistant (PDA), an MP3 player, or other such device. According to one exemplary embodiment, any suitable processor may be used, including, but in no way limited to a processor configured to reside directly on the media processing system. Additionally, as graphically shown in FIG. 1, the processor (125) may have firmware (123) such as software or other drivers associated therewith, configured to control the operation of the radiation generating device (110) to selectively apply radiation to the data storage medium (130). According to one exemplary embodiment, the firmware (123) configured to control the operation of the radiation generating device (110) may be stored on a data storage device (not shown) communicatively coupled to the processor (125) including, but in no way limited to, read only memory (ROM), random access memory (RAM), and the like.

As introduced, the processor (125) is configured to controllably interact with the radiation generating device (110). While FIG. 1 illustrates a single radiation generating device (110), any number of radiation generating devices may be incorporated in the media processing system (100). According to one exemplary embodiment, the radiation generating device (110) may include, but is in no way limited to one or more lasers configured for forming data on a CD and/or DVD. The one or more lasers may be specifically configured to radiate one of a CD or a DVD. Alternatively, the one or more lasers of the radiation generating device (110) may include multiple lasers operating at different wavelengths, such as in a combo CD/DVD recording drive. More specifically, a combo CD/DVD recording drive configured to record on more than one type of media may be incorporated by the media processing system (100). For example, a DVD-R/RW (±) combo drive is also capable of recording CD-R/RW for example. In order to facilitate recording on more than one type of media, these combo CD/DVD recording drives include more than one laser. For example combo CD/DVD recording drives often contain 2 recording lasers: a first laser operating at approximately 780 nm for CD recordings and a second laser operating at approximately 650 nm for DVD recordings. Accordingly, the present media processing system (100) may include any number of lasers having wavelengths that may vary from between approximately 200 nm to approximately 1200 nm.

As mentioned previously, the present media processing system (100) includes a data storage medium in the form of a radiation imageable disc (130) disposed adjacent to the radiation generating device (110). According to one exemplary embodiment, the exemplary radiation imageable disc (130) includes first (140) and second (150) opposing sides. The first side (140) has a data surface formed thereon configured to store data while the second side (150) includes a radiation imageable surface having a color forming composition.

With respect to the first side (140) of the radiation imageable disc (130), the radiation generating device (110) may be configured to read existing data stored on the radiation imageable disc (130) and/or to store new data on the radiation imageable disc (130), as is well known in the art. As used herein, the term “data” is meant to be understood broadly as including the non-graphic information digitally or otherwise embedded on a radiation imageable disc. According to the present exemplary embodiment, data can include, but is in no way limited to, audio information, video information, photographic information, software information, and the like. Alternatively, the term “data” may also be used herein to describe information such as instructions a computer or other processor may access to form a graphic display on a radiation imageable surface.

In contrast to the first side of the radiation imageable disc (130), the second side of the radiation imageable disc (140) includes a two-phase radiation imageable coating including an optional sensitizer that may be selected to correspond to an available radiation source. According to one exemplary embodiment, discussed in further detail below, the second side of the radiation imageable disc (140) includes two separate phases: a first phase including a radiation-curable polymer matrix with an acidic activator species dissolved therein, and a second phase including a low-melting eutectic of a leuco-dye insoluble in the polymer matrix but uniformly distributed therein as a fine dispersion. Additionally, an optional sensitizing agent in the form of an antenna dye or other radiation absorbing species is dispersed and/or dissolved in one or both of the two phases of the coating. Further details of the radiation-curable radiation imageable coating that may be customized with an optional sensitizer to match a radiation output of a radiation source will be provided below.

### Exemplary Coating Formulation

As mentioned above, the second side of the radiation imageable disc (140) includes a number of components forming two separate phases configured to be imaged by one or more lasers emitting radiation at a known wavelength. According to one exemplary embodiment, the two separate phases forming the present coating formulation include, but are in no way limited to, a radiation-curable polymer matrix with acidic activator species dissolved therein and a leuco-dye insoluble in the matrix but uniformly distributed therein as a fine dispersion. The leuco-dye may be, according to one exemplary embodiment, a low-melting eutectic. Additionally, the coating formulation may be optionally sensitized by the inclusion of an antenna dye of other laser radiation absorbing species uniformly distributed/dissolved in at least one and preferably both phase(s) of the coating if desired for the identified laser radiation power. Each of the present phases will be described in detail below.

As mentioned, the first phase of the dual band radiation imageable thermochromic coating includes, but is in no way limited to, a radiation-curable polymer matrix with acidic activator species dissolved therein. According to one exemplary embodiment, the radiation curable pre-polymer, in the form of monomers or oligomers, may be a lacquer configured to form a continuous phase, referred to herein as a matrix phase, when exposed to light having a specific wavelength. More specifically, according to one exemplary embodiment, the radiation curable polymer may include, by way of example, UV-curable matrices such as acrylate derivatives, oligomers, and monomers, with a photo package. A photo package may include a light absorbing species, such as photoinitiators, which initiate reactions for curing of the lacquer, such as, by way of example, benzophenone derivatives. Other examples of photoinitiators for free radical polymerization monomers and oligomers include, but are not limited to, thioxanethone derivatives, anthraquinone derivatives, acetophenones, benzoine ethers, and the like.

Matrices based on cationic polymerization resins may require photoinitiators based on aromatic diazonium salts, aromatic halonium salts, aromatic sulfonium salts and metallocene compounds. A suitable lacquer or matrix may also include Nor-Cote CLCDG-1250A (a mixture of UV curable acrylate monomers and oligomers) which contains a photoinitiator (hydroxyl ketone) and organic solvent acrylates, such as, methyl methacrylate, hexyl methacrylate, beta-phenoxy ethyl acrylate, and hexamethylenediol diacrylate. Other suitable components for lacquers or matrices may include, but are not limited to, acrylated polyester oligomers, such as CN293 and CN294 as well as CN-292 (low viscosity polyester acrylate oligomer), bis-phenol A epoxyacrylate oligomers such as Ebecryl-605, trimethylolpropane triacrylate commercially known as SR-351, 1,6-hexanediol diacrylate commercially known as SR-238, tripropylene glycol diacrylate commercially known as SR306HP, isodecyl acrylate commercially known as SR-395, isobornyl acrylate commercially known as SR506 and 2(2-ethoxyethoxy)ethyl acrylate commercially known as SR-256, all of which are commercially available from Sartomer Co.

Additionally, a number of acidic developers may be dispersed/dissolved in the present radiation curable polymer matrix. According to one exemplary embodiment, the acidic developers present in the radiation curable polymer matrix may include, but are not limited to, a phenolic species capable of developing color when reacting with a leuco dye and soluble or partially soluble in the coating matrix phase. Suitable developers for use with the present exemplary system and method include, but are in no way limited to, acidic phenolic compounds such as, for example, Bis-Phenol A, p-Hydroxy Benzyl Benzoate, Bisphenol S (4,4-Dihydroxydiphenyl Sulfone), 2,4-Dihydroxydiphenyl Sulfone, Bis(4-hydroxy-3-allylphenyl)sulfone (Trade name—TG-SA), 4-Hydroxyphenyl-4′-isopropoxyphenyl sulfone (Trade name—D8). The acidic developer may be either completely or at least partially dissolved in the UV-curable matrix.

The second phase of the present two-phase radiation imageable thermochromic coating is a color-former phase including, according to one exemplary embodiment, a leuco-dye and/or leuco-dye alloy, further referred to herein as a leuco-phase. According to one exemplary embodiment, the leuco-phase is present in the form of small particles dispersed uniformly in the exemplary coating formulation. According to one exemplary embodiment, the leuco-phase includes leuco-dye or alloy of leuco-dye with a mixing aid configured to form a lower melting eutectic with the leuco-dye. Alternatively, according to one embodiment, the second phase of the present radiation curable polymer matrix may include other color forming dyes such as photochromic dyes.

According to one exemplary embodiment, the present two-phase radiation imageable thermochromic coating may have any number of leuco dyes including, but in no way limited to, fluorans, phthalides, aminotriarylmethanes, aminoxanthenes, aminothioxanthenes, amino-9,10-dihydroacridines, aminophenoxazines, aminophenothiazines, aminodihydrophenazines, aminodiphenylmethanes, aminohydrocinnamic acids (cyanoethanes, leuco methines) and corresponding esters, 2(phydroxyphenyl)-4,5-diphenylimidazoles, indanones, leuco indamines, hydrozines, leuco indigoid dyes, amino-2,3-dihydroanthraquinones, tetrahalop, p′-biphenols, 2(p-hydroxyphenyl)-4,5-diphenylimidazoles, phenethylanilines, and mixtures thereof. According to one particular aspect of the present exemplary system and method, the leuco dye can be a fluoran, phthalide, aminotriarylmethane, or mixture thereof. Several nonlimiting examples of suitable fluoran based leuco dyes include, but are in no way limited to, 3-diethylamino-6-methyl-7-anilinofluorane, 3-(N-ethyl-p-toluidino)-6-methyl-7-anilinofluorane, 3-(N-ethyl-N-isoamylamino)-6-methyl-7-anilinofluorane, 3-diethylamino-6-methyl-7-(o,p-dimethylanilino)fluorane, 3-pyrrolidino-6-methyl-7-anilinofluorane, 3-piperidino-6-methyl-7-anilinofluorane, 3-(N-cyclohexyl-Nmethylamino)-6-methyl-7-anilinofluorane, 3-diethylamino-7-(mtrifluoromethylanilino)fluorane, 3-dibutylamino-6-methyl-7-anilinofluorane, 3-diethylamino-6-chloro-7-anilinofluorane, 3-dibutylamino-7-(o-chloroanilino)fluorane, 3-diethylamino-7-(o-chloroanilino)fluorane, 3-di-n-pentylamino-6-methyl-7-anilinofluoran, 3-di-n-butylamino-6-methyl-7-anilinofluoran, 3-(n-ethyln-isopentylamino)-6-methyl-7-anilinofluoran, 3-pyrrolidino-6-methyl-7-anilinofluoran, 1(3H)-isobenzofuranone,4,5,6,7-tetrachloro-3,3-bis[2-[4-(dimethylamino)phenyl]-2-(4-methoxyphenyl)ethenyl], and mixtures thereof.

Aminotriarylmethane leuco dyes can also be used in the present invention such as tris(N,N-dimethylaminophenyl)methane (LCV); tris(N,N-diethylaminophenyl)methane(LECV); tris (N,N-di-n-propylaminophenyl)methane (LPCV); tris(N,N -dinbutylaminophenyl)methane (LBCV); bis(4-diethylaminophenyl)-(4-diethylamino-2-methyl-phenyl)methane (LV-1); bis(4-diethylamino-2-methylphenyl)-(4-diethylamino-phenyl)methane (LV-2); tris(4-diethylamino-2-methylphenyl)methane (LV-3); bis(4-diethylamino-2-methylphenyl)(3,4-dimethoxyphenyl)methane (LB-8); aminotriarylmethane leuco dyes having different alkyl substituents bonded to the amino moieties wherein each alkyl group is independently selected from C1-C4 alkyl; and aminotriaryl methane leuco dyes with any of the preceding named structures that are further substituted with one or more alkyl groups on the aryl rings wherein the latter alkyl groups are independently selected from C1-C3 alkyl.

Additional leuco dyes can also be used in connection with the present exemplary systems and methods and are known to those skilled in the art. A more detailed discussion of appropriate leuco dyes may be found in U.S. Pat. Nos. 3,658,543 and 6,251,571, each of which are hereby incorporated by reference in their entireties. Additionally examples may be found in Chemistry and Applications of Leuco Dyes, Muthyala, Ramaiha, ed.; Plenum Press, New York, London; ISBN: 0-306-45459-9, incorporated herein by reference.

Further, according to one exemplary embodiment, a number of melting aids may be included with the above-mentioned leuco dyes. As used herein, the melting aids may include, but are in no way limited to, crystalline organic solids with melting temperatures in the range of approximately 50° C. to approximately 150° C., and preferably having melting temperature in the range of about 70° C. to about 120° C. In addition to aiding in the dissolution of the leuco-dye and the antenna dye, the above-mentioned melting aid may also assist in reducing the melting temperature of the leuco-dye and stabilize the leuco-dye alloy in the amorphous state, or slow down the re-crystallization of the leuco-dye alloy into individual components. Suitable melting aids include, but are in no way limited to, aromatic hydrocarbons (or their derivatives) that provide good solvent characteristics for leuco-dye and antenna dyes used in the present exemplary systems and methods. By way of example, suitable melting aids for use in the current exemplary systems and methods include, but are not limited to, m-terphenyl, pbenzyl biphenyl, alpha-naphtol benzylether, 1,2(bis[3,4]dimethylphenyl)ethane. When used, the melting aid can comprise from approximately 2 wt % to approximately 25 wt % of the color-former phase.

According to one embodiment of the present exemplary system and method, the above-mentioned leuco-phase is uniformly dispersed or distributed in the matrix phase as a separate phase. In other words, at ambient temperature, the leuco phase is practically insoluble in matrix phase. Consequently, the leuco-dye and the acidic developer component of the matrix phase are contained in the separate phases and can not react with color formation at ambient temperature. However, upon heating with laser radiation, both phases melt and mix. Once mixed together, color is developed due to a reaction between the fluoran leuco dye and the acidic developer. According to one exemplary embodiment, when the leuco dye and the acidic developer melt and react, proton transfer from the developer opens a lactone ring of the leuco-dye, resulting in an extension of conjugate double bond system and color formation.

According to one exemplary embodiment, the above-mentioned coating may be selectively irradiated with a laser or other radiation source to cause a desired interaction and form the desired color, without ablation at power levels between approximately 0.5 and 1.5 watts, independent of the laser wavelength. While high laser power levels between approximately 0.5 and 1.5 watts may be appropriate for a label device forming labels on generic substrates in an open environment, such high power lasers are relatively expensive. Additionally, many desirable label forming environments cannot incorporate such high power lasers due to thermal issues, such as in computing devices incorporating optical disc media.

Consequently, according to one exemplary embodiment, the formation of the color with relatively low power lasers may also be facilitated by the present exemplary system and method by selectively sensitizing the various phases of the resulting coating to a known radiation emission wavelength via the use of an optional antenna dye or other radiation absorbing material, thereby providing maximum heating efficiency. According to one exemplary embodiment, the optional antenna dyes may include any number of radiation absorbers selectively chosen to correspond with a known radiation at a predetermined exposure time, energy level, wavelength, etc. More specifically, the radiation absorbing antenna dye(s) may act as an energy antenna providing energy to surrounding areas of the resulting coating upon interaction with an energy source of a known wavelength. Once energy is received by the radiation absorbing antenna dyes, the radiation is converted to heat to melt portions of the coating and selectively induce image formation. However, radiation absorbing dyes have varying absorption ranges and varying absorbency maximums where the antenna dye will provide energy most efficiently from a radiation source. Generally speaking, an optional radiation antenna that has a maximum light absorption at or in the vicinity of a desired development wavelength may be suitable for use in the present system and method.

As a predetermined amount and frequency of radiation is generated by the radiation generating device (110) of the media processing system (100), matching the radiation absorbing energy antenna to the radiation wavelengths and intensities of the first and second radiation generating devices can optimize the image formation system. Optimizing the system includes a process of selecting components of the color forming composition that can result in a rapidly developable composition under a fixed period of exposure to radiation at a specified power.

According to one exemplary embodiment, the present two-phase radiation imageable coating having an optional sensitizer may include an antenna package uniformly distributed/dissolved in at least one and preferably both phase(s) of the coating in order to customize the resulting coating to a radiation at a specified wavelength and reduced power. According to the present exemplary embodiment, the antenna dyes included in the present optional antenna package may be selected from a number of radiation absorbers such as, but not limited to, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures or derivatives thereof. Other suitable antennas can also be used in the present exemplary system and method and are known to those skilled in the art and can be found in such references as “Infrared Absorbing Dyes”, Matsuoka, Masaru, ed., Plenum Press, New York, 1990 (ISBN 0-306-43478-4) and “Near-Infrared Dyes for High Technology Applications”, Daehne, Resch-Genger, Wolfbeis, Kluwer Academic Publishers (ISBN 0-7923-5101-0), both incorporated herein by reference.

According to the present exemplary embodiment, optional antenna dyes included in the present antenna package may be selected to correspond to a radiation generated by a known radiation generating device (110). According to one exemplary embodiment, the media processing system (100) may include a radiation generating device configured to produce one or more lasers with wavelength values including, but in no way limited to, approximately 300 nm to approximately 600 nm, approximately 650 nm, approximately 780 nm, approximately 808 nm, and/or approximately 10.6 μm. By selectively matching the wavelength values of the radiation generating device(s) (110), image formation is maximized at lower power levels. According to one exemplary embodiment, the image formation using the optional antenna dyes may be performed at power levels as low as 5 mW and lower.

As mentioned, a number of dyes having varying absorbance maximums may be optionally incorporated into the above-mentioned coatings to act as radiation absorbing antenna dyes, thereby reducing the minimum laser power used to initiate color formation.

According to one exemplary embodiment, optional antenna dyes that may be used to selectively sensitize the above-mentioned coating to a wavelength of between approximately 300 nm and 600 nm include, but are in no way limited to, cyanine and porphyrin dyes such as etioporphyrin 1 (CAS 448-71-5), phthalocyanines and naphthalocyanines such as ethyl 7-diethylaminocoumarin-3-carboxylate (λ max=418 nm). Specifically, according to one exemplary embodiment, appropriate optional antenna dyes include, but are in no way limited to, aluminum quinoline complexes, porphyrins, porphins, and mixtures or derivatives thereof. Non-limiting specific examples of suitable radiation antenna can include 1-(2-chloro-5-sulfophenyl)-3-methyl-4-(4-sulfophenyl)azo-2-pyrazolin-5-one disodium salt (λ max=400 nm); ethyl 7-diethylaminocoumarin-3-carboxylate (λ max=418 nm); 3,3′-diethylthiacyanine ethylsulfate (λmax=424 nm); 3-allyl-5-(3-ethyl-4-methyl-2-thiazolinylidene)rhodanine (λ max=430 nm) (each available from Organica Feinchemie GmbH Wolfen), and mixtures thereof.

Non-limiting specific examples of suitable aluminum quinoline complexes can include tris(8-hydroxyquinolinato)aluminum (CAS 2085-33-8), and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1,2-d]1,3-dithiole, all available from Syntec GmbH.

Non-limiting examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange (CAS 2243-76-7), Merthyl Yellow (CAS 60-11-7), 4-phenylazoaniline (CAS 60-09-3), Alcian Yellow (CAS 61968-76-1), available from Aldrich chemical company, and mixtures thereof.

Further, in order to sensitize the above-mentioned coating to a radiation wavelength of approximately 650 nm, many indolium of phenoxazine dyes and cyanine dyes such as cyanine dye CS172491-72-4 may be selectively incorporated into one or more phases of the above-mentioned coating. Additionally, dyes having absorbance maximums at approximately 650 nm may be used including, but in no way limited to many commercially available phthalocyanine dyes such as pigment blue 15.

Further, radiation absorbing antenna dyes having absorbance maximums at approximately 650 nm according to their extinction coefficient that may be selectively incorporated into the present antenna dye package to reduce the power level initiating a color change in the coating include, but are in no way limited to, dye 724 (3H-Indolium, 2-[5-(1,3-dihydro-3,3-dimethyl-1-propyl-2H-indol-2-ylidene)-1,3-pentadienyl]-3,3-dimethyl-1-propyl-, iodide) (λ max=642 nm), dye 683 (3H-Indolium, 1-butyl-2-[5-(1-butyl-1,3-dihydro-3,3-dimethyl-2H-indol-2-ylidene)-1,3-pentadienyl]-3,3-dimethyl-, perchlorate (λ max=642 nm), dyes derived from phenoxazine such as Oxazine 1 (Phenoxazin-5-ium, 3,7-bis (diethylamino)-, perchlorate) (λ max=645 nm), available from “Organica Feinchemie GmbH Wollen.” Appropriate antenna dyes applicable to the present exemplary system and method may also include but are not limited to phthalocyanine dyes with light absorption maximum at/or in the vicinity of 650 nm.

Radiation absorbing antenna dyes having absorbance maximums at approximately 780 nm that may be incorporated into the present antenna dye package include, but are in no way limited to, many indocyanine IR-dyes such as IR780 iodide (Aldrich 42,531-1) (1) (3H-Indolium, 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propyl-, iodide (9Cl)), IR783 (Aldrich 54,329-2) (2) (2-[2-[2-Chloro-3-[2-[1,3-dihydro-3,3-dimethyl-1-(4-sulfobutyl)-2H indol-2-ylidene]-ethylidene]-1-cyclohexen-1-yl]-ethenyl]-3,3-dimethyl-1-(4-sulfobutyl)-3H-indolium hydroxide, inner salt sodium salt). Additionally, low sensitivity/higher stability dyes having absorbance maximums at approximately 780 nm may be used including, but in no way limited to NIR phthalocyanine or substituted phthalocyanine dyes such as Cirrus 715 dye from Avecia, YKR186, and YKR3020 from Yamamoto chemicals

Similarly, high sensitivity/lower stability radiation absorbing antenna dyes having absorbance maximums at approximately 808 nm that may be incorporated into the present coating include, but are in no way limited to, Indocyanine dyes such as 3H-Indolium, 2-[2-[2-chloro-3-[(1,3-dihydro-1,3,3-trimethyl-2H-indol-2-ylidene)ethylidene]-1-cyclopenten-1-yl]ethenyl]-1,3,3-trimethyl-, salt with 4-methylbenzenesulfonic acid (1:1) (9Cl), (Lambda max-797 nm), CAS No. 193687-61-5, available from “Few Chemicals GMBH” as S0337; 3H-Indolium, 2-[2-[3-[(1,3-dihydro-1,3,3-trimethyl-2H-indol-2-ylidene)ethylidene]-2-[(1-phenyl-1H-tetrazol-5-yl)thio]-1-cyclohexen-1-yl]ethenyl]-1,3,3-trimethyl-, chloride (9Cl), (Lambda max-798 nm), CAS No. 440102-72-7 available from “Few Chemicals GMBH” as S0507; 1H-Benz[e]indolium, 2-[2-[2-chloro-3-[(1,3-dihydro-1,1,3-trimethyl-2H-benz[e]indol-2-ylidene)ethylidene]-1-cyclohexen-1-yl]ethenyl]-1,1,3-trimethyl-chloride (9Cl), (Lambda max-813 nm), CAS No. 297173-98-9 available from “Few Chemicals GMBH” as S0391; 1H-Benz[e]indolium, 2-[2-[2-chloro-3-[(1,3-dihydro-1,1,3-trimethyl-2H-benz[e]indol-2-ylidene)ethylidene]-1-cyclohexen-1-yl]ethenyl]-1,1,3-trimethyl-, salt with 4-methylbenzenesulfonic acid (1:1) (9Cl), (Lambda max-813 nm), CAS No. 134127-48-3, available from “Few Chemicals GMBH” as S0094, also known as Trump Dye or Trump IR; and 1H-Benz[e]indolium, 2-[2-[2-chloro-3-[(3-ethyl-1,3-dihydro-1,1-dimethyl-2Hbenz[e]indol-2-ylidene)ethylidene]-1-cyclohexen-1-yl]ethenyl]-3-ethyl-1,1-dimethyl-, salt with 4-methylbenzenesulfonic acid (1:1) (9Cl) (Lambda max-816 nm), CAS No. 460337-33-1, available from “Few Chemicals GMBH” as S0809.

Moreover, species absorbing IR radiation in the vicinity of 10.6 um(10,600 nm) that may be selectively incorporated into the present coating are not necessarily dyes (many of them could be colorless). Rather, a number of organic substances may have stretching or bending vibrational IR absorption bands in this region. Still IR-absorbing efficiency of the coating toward 10.6 um radiation may be significantly enhanced if it contains species with functional groups highly absorptive in this region. Examples of the species with possible strong absorption band in vicinity of 10.6 μm include, but are not limited to, some organic species with structures containing vinyl group (—CH═CH2); some species with —SH (thiol) group; and species with covalent phosphates (R—O)3P═O.

Furthermore IR-absorbing antenna additive pigments that absorb long-wave infrared (IR) (in the vicinity of 10.6 um) could be added to further enhance the marking performance of the coating. For example Menatec 230-A-IR (by Merk) could be added up to 20% by weight to the ink.

Exemplary methods of forming the above-mentioned coatings, as well as methods for forming images on the coating are described in further detail below.

### Exemplary Coating Forming Method

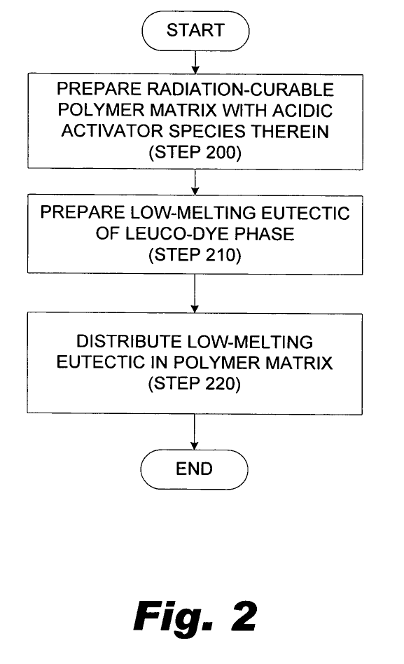

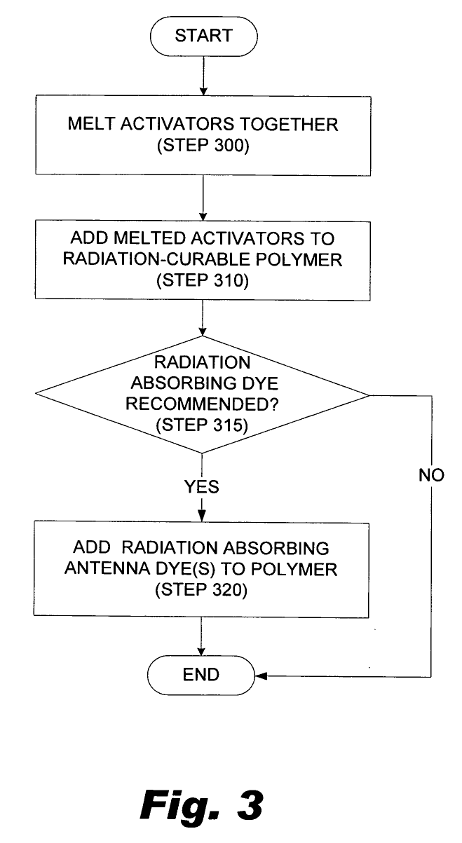

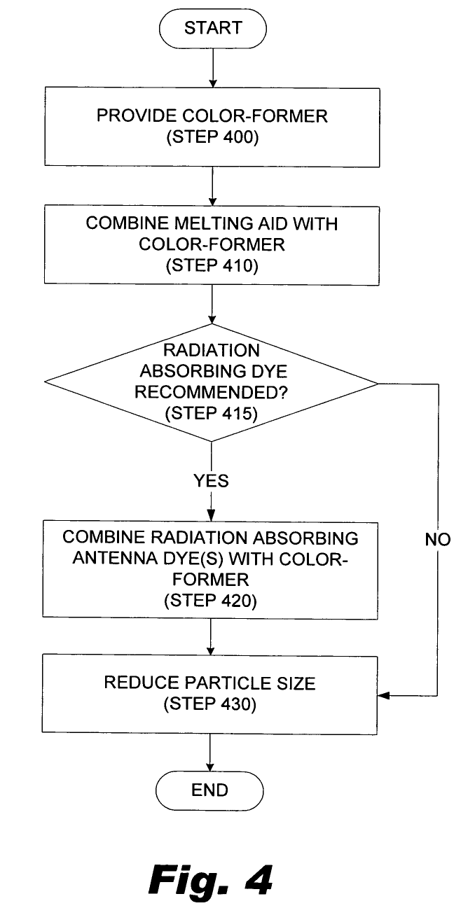

FIG. 2 is a flowchart illustrating a method of forming the present two-phase radiation imageable thermochromic coating, according to one exemplary embodiment. In general, a method of forming the imageable thermochromic coating includes preparing the radiation-curable polymer matrix with an acidic activator species dissolved therein (step 200), preparing a low-melting eutectic of a leuco-dye (step 210), and evenly distributing the low-melting eutectic of a leuco-dye in the radiation curable polymer matrix (step 220). Further details of the exemplary coating forming method will now be described in further detail below with reference to FIGS. 3 and 4.

As mentioned with reference to FIG. 2, a first step of the present exemplary coating formation method includes preparing the radiation-curable polymer matrix with an acidic activator species therein (step 200). FIG. 3 further illustrates an exemplary method for preparing the radiation-curable polymer matrix, according to one exemplary embodiment. As illustrated in FIG. 3, the radiation-curable polymer matrix may be prepared by first melting the acidic, proton-donating activator species together (step 300). In some embodiments, multiple activators can be used, e.g., multiple activator systems having coequal performance values to systems having a primary activator and secondary activator(s). While the present exemplary method includes the step of melting the activators together to accelerate dissolution of activator species that may exhibit poor solubility in the radiation curable polymer, the step of melting the activators together is optional. Rather, in many cases, the activators may be directly dissolved in the radiation-curable polymer without preliminary melting.

Once the desired activators have been optionally melted together (step 300), the melted activators are added to the radiation-curable polymer (step 310). According to one exemplary embodiment, the proton-donating activator species are dissolved into the radiation-curable polymer. Dissolution of the proton-donating activator species may be facilitated by the introduction of agitation into the radiation-curable polymer. Dissolution of the proton-donating activator species in the radiation-curable polymer (step 310) will provide for a substantially even distribution of the activators throughout the polymer.

Once the desired activators have been dissolved in the radiation curable polymer (step 310), it is determined if the intended radiation generating device is configured to initiate a color forming process on the exemplary coating without the use of one or more radiation absorbing antenna dyes, or whether a radiation absorbing antenna dye is recommended (step 315). According to the exemplary method, if it is determined that one or more radiation absorbing antenna dye(s) is not recommended due to the high power capabilities of the identified radiation generating device (NO, step 315), the formation of the radiation-curable polymer matrix is complete.

If, however it is determined that one or more radiation absorbing antenna dye(s) is recommended to facilitate a low power color forming operation (YES, step 315), antenna dye(s) corresponding to the intended radiation generating device are added to the radiation-curable polymer (step 320). According to the present exemplary method, the above-mentioned antenna package may be introduced to the two phases of the present exemplary coating according to any number of different methodologies. According to a first exemplary embodiment, the antenna dyes may be dissolved/uniformly distributed in only the coating polymer matrix phase. According to a second exemplary embodiment, the antenna dye(s) of the antenna package may be dissolved/uniformly distributed in the leuco-dye phase. According to yet a third exemplary embodiment, the antenna dye(s) may be uniformly distributed and/or dissolved in both phases of the thermochromic coating. Regardless of the antenna dye distribution, the selected antenna dyes may be selected as having absorbance maximums associated with the wavelength(s) of the radiation generating device(s) (110; FIG. 1). According to one exemplary embodiment, the antenna dyes are dissolved into the various phases to provide a substantially even distribution thereof.

Once the radiation-curable polymer matrix is formed (step 200; FIG. 2), a low-melting eutectic of the leuco dye phase may also be formed (step 210; FIG. 2). According to one exemplary embodiment illustrated in FIG. 4, the leuco dye phase is formed by first providing the color-former (step 400). As mentioned previously, the color-former may include, but is in no way limited to, leuco-dye and/or leuco-dye alloy. As used herein, the term “color-former” refers to any composition that changes color upon application of energy. Color-formers may include, but are in no way limited to, leuco dyes, photochromic dyes, or the like. For example, the color-former may include leuco dyes, such as fluoran, isobenzofuran, and phthalide-type leuco dyes. The term “color-former” does not infer that color is generated from scratch, as it includes materials that can change in color, as well as materials that can become colored from a colorless or more transparent state or a different color. The resulting molten mixture may be referred to as a molten color-former phase. Additionally, according to one exemplary embodiment, a melting aid may be combined with the above-mentioned color-former (step 410). The melting aid may be a crystalline organic solid melted with the color-former, according to one exemplary embodiment. Melting aids are typically crystalline organic solids that can be melted and mixed with a particular color-former. For example, most color-formers are also available as a solid particulate that is soluble in standard liquid solvents. Thus, the color-former and melting aid can be mixed and heated to form a molten mixture. Upon cooling, a color-former phase of color-former and melting aid is formed that can then be ground into a powder.

When the color-former and the melting aid are combined (step 410), it is again determined if the intended radiation generating device is configured to initiate a color forming process on the exemplary coating without the use of one or more radiation absorbing antenna dyes, or whether a radiation absorbing antenna dye is recommended (step 415). According to the exemplary method, if it is determined that one or more radiation absorbing antenna dye(s) is not recommended due to the high power capabilities of the identified radiation generating device (NO, step 415), the formation of the leuco dye phase is substantially complete and only the particle size reduction (step 430) remains.

If, however it is determined that one or more radiation absorbing antenna dye(s) is recommended to facilitate a low power color forming operation (YES, step 415), antenna dye(s) corresponding to the intended radiation generating device are added to the leuco dye phase (step 420), according to one exemplary embodiment. As mentioned previously, the radiation absorbing dyes that are mixed with the color-former may be selected based on the wavelength or range of wavelengths produced by the intended radiation generating device(s).

Additionally, as mentioned previously, the radiation absorbing dyes that are mixed with the color-former may be mixed according to one of three different embodiments, as mentioned above with reference to FIG. 3.

Once the above-mentioned components are melted, the molten low-melting eutectic of the leuco dye phase is allowed to cool and the particle size of the low-melting eutectic of the leuco dye phase is reduced (step 430). The particle size of the low-melting eutectic of the leuco dye phase may be reduced by any number of known methods including, but in no way limited to, milling and/or grinding.

Returning again to the method illustrated in FIG. 2, once both the radiation-curable polymer matrix and the low-melting eutectic of the leuco-dye phase are formed, the low melting eutectic is distributed in the polymer matrix (step 220). According to one exemplary embodiment, the low-melting eutectic of the leuco-dye phase may be distributed in the polymer with the aid of continuous agitation during introduction of the low melting eutectic in the polymer matrix.

When the two-phase radiation imageable thermochromic coating is formed as described above, it may be applied to any number of desired substrates including, but in no way limited to, polymer, paper, ceramic, glass, metal, and the like. According to one exemplary embodiment, the radiation imageable thermochromic coating may be applied to a desired substrate using any number of known coating systems and methods including, but in no way limited to, doctor blade coating, gravure coating, reverse roll coating, meyer rod coating, extrusion coating, curtain coating, air knife coating, and the like.

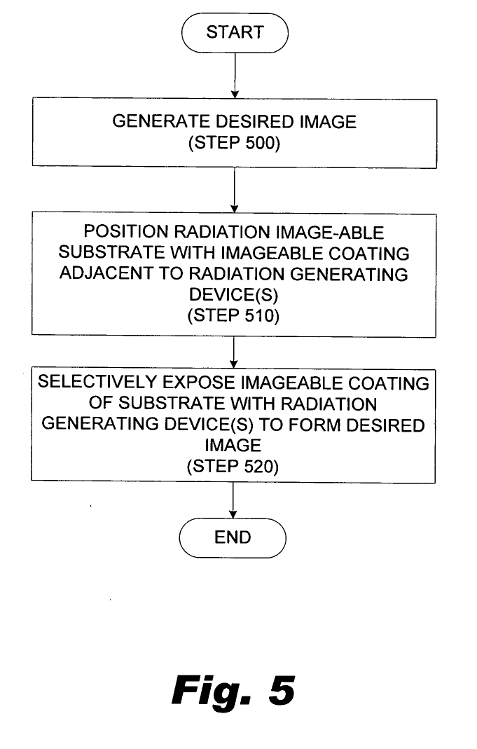

If the above-mentioned coating is formed on a radiation imageable disc (130; FIG. 1), data may be formed on the data surface of the first side (140) of the disc, and/or a desired image may be formed via selective radiation exposure on the second side (150). FIG. 5 illustrates one exemplary method for forming a desired image on the second side (150) of the radiation imageable disc (130), according to one exemplary embodiment. As illustrated in FIG. 5, the image formation method begins by first generating the desired image (step 500). According to one exemplary embodiment, generating the desired image may include forming a graphical representation of the desired image using any number of user interfaces and converting the graphical representation into a number of machine controllable commands using the firmware (123; FIG. 1) and/or the processor (125; FIG. 1) of the media processing system (100; FIG. 1).

Continuing with FIG. 5, the radiation imageable disc may then be placed adjacent to the radiation generating device(s) (110; FIG. 1) with the radiation imageable coating in optical communication with the radiation generating device(s) (step 510). With the radiation imageable coating in optical communication with the radiation generating device(s) (step 510), the radiation imageable coating may then be selectively exposed to the radiation generating device(s) to form the desired image (step 520).

According to the present exemplary embodiment, the use of an optional sensitizing antenna allows users to customize the sensitivity of the thermocromic coating for optimal performance based on the irradiance available. Further, by providing the ability to generate a thermocromic coating without the optional sensitizing antenna provides the ability to use high power lasers without ablation. According to this exemplary embodiment, the high power lasers may have exemplary powers of approximately 3 W/cm². This ability to use high power lasers further facilitates laser imaging on fast moving production lines such as food packaging or high volume label production. Moreover, the ability to use low power lasers without ablation, such as lasers having power levels of approximately 30 mW /cm², facilitates laser imaging environments where high power lasers are impractical due to cost and/or thermal limitations, such as in optical disc drives.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A method of forming a radiation imageable coating comprising:
preparing a radiation-curable polymer matrix including an acidic activator species;
forming a leuco-dye phase;
distributing said leuco-dye phase in said polymer matrix;
evaluating a power level of a chosed radiation source; and
if said power level of said chosed radiation source is less than approximately 1 watt/cm², sensitizing said radiation imageable coating with a sensitizing agent corresponding to said chosed radiation source.

2. The method of claim 1, wherein said sensitizing said radiation imageable coating with a sensitizing agent comprises distributing an antenna dye in said radiation imageable coating;
wherein said antenna dye has an absorbance maximum wavelength that corresponds to a wavelength of said chosed radiation source.

3. The method of claim 2, wherein said sensitizing said radiation imageable coating with an antenna dye further comprises distributing said antenna dye in said leuco-dye phase.

4. The method of claim 2, further comprising selecting said antenna dye to have an absorbance maximum wavelength to correspond to a chosed radiation source having a wavelength of approximately 405 nm, 650 nm, 780 nm, or 808 nm.

5. The method of claim 1, wherein said sensitizing said radiation imageable coating with a sensitizing agent comprises distributing a sensitizing agent in said radiation imageable coating;
wherein said sensitizing agent has a vibrational absorption band near approximately 10,600 nm.

6. The method of claim 2, wherein said sensitizing said radiation imageable coating with an antenna dye further comprises distributing said antenna dye in said radiation curable polymer matrix.

7. The method of claim 1, wherein said preparing a radiation-curable polymer matrix including an acidic activator species comprises:
melting a plurality of acidic activator species; and
adding said melted activators to a radiation-curable polymer.

8. The method of claim 1, wherein said forming a leuco-dye phase comprises:
providing a color-former;
combining a melting aid with said color-former.

9. The method of claim 8, further comprising reducing a particle size of said color-former.

10. The method of claim 1, further comprising not sensitizing said radiation imageable coating with a sensitizing agent if said power level of said chosed radiation source is greater than approximately 1 watt/cm².

11. The method of claim 1, wherein said leuco-dye phase comprises a low-melting eutectic of a leuco-dye.

12. A radiation imageable coating configured for use with a radiation source having a known power level, comprising:
a first phase including a radiation curable polymer matrix and an activator disposed in said radiation curable polymer matrix;
a second phase insolubly distributed in said first phase, said second phase including a color-former; and
if said known power level is less than approximately 1 watt/cm², a sensitizing agent distributed in at least one of said first and second phase.

13. The coating of claim 12, wherein said sensitizing agent comprises an antenna dye is distributed in both said first phase and said second phase;
wherein said antenna dye corresponds with a wavelength of said radiation source.

14. The coating of claim 12, wherein said color-former comprises one of a leuco-dye or a leuco-dye alloy.

15. The coating of claim 12, wherein said color-former comprises a low-melting eutectic of one of a leuco-dye or a leuco-dye alloy.

16. The coating of claim 12, wherein said color-former comprises a low-melting eutectic of a fluorane leuco-dye.

17. The coating of claim 12, wherein said sensitizing agent has an absorbance maximum wavelength comprising one of approximately 10,600 nm, approximately 808 nm, approximately 780 nm, approximately 650 nm, or approximately 405 nm.

18. The coating of claim 12, wherein said activator comprises an acidic activator species dissolved in said first phase.

19. The coating of claim 12, wherein said second phase comprises a dispersion within said first phase.

20. The coating of claim 12, wherein said second phase further comprises a melting aid configured to decrease the melting temperature of said eutectic.

21. The coating of claim 12, wherein said sensitizing agent is not distributed in either of said first phase or said second phase if said known power level is greater than approximately 1 watt/cm².

22. A radiation imageable coating configured for use with a radiation source having a known power level, comprising:
a first phase including a radiation curable polymer matrix and an activator disposed in said radiation curable polymer matrix;
a second phase insolubly distributed in said first phase, said second phase including a color-former; and
if said known power level is greater than approximately 1 watt/cm², not inserting a sensitizing agent in said radiation imageable coating.

23. The coating of claim 22, wherein said color-former comprises a low-melting eutectic of one of a leuco-dye or a leuco-dye alloy.

24. The coating of claim 22, wherein said color-former comprises a low-melting eutectic of a fluorane leuco-dye.

25. A method of forming an image on a substrate with a radiation source of a known power level and wavelength comprising:
forming a radiation imageable coating on a desired substrate, wherein said radiation imageable coating includes a first phase including a radiation curable polymer matrix and an activator disposed in said radiation curable polymer matrix, a second phase insolubly distributed in said first phase, said second phase including a color-former, and if said known power level is less than approximately 1 watt/cm², a sensitizing agent distributed in at least one of said first and second phase; and
selectively exposing said radiation imageable coating to said radiation source of a known power level and wavelength.

26. The method of claim 25, wherein said sensitizing agent comprises an absorbance maximum wavelength of said antenna dye.

27. The method of claim 26, wherein said sensitizing agent comprises an antenna dye is distributed in both said first phase and said second phase.

28. The method of claim 25, wherein said radiation source comprises a laser having a wavelength of one of approximately 10,600 nm, approximately 808 nm, approximately 780 nm, approximately 650 nm, or approximately 405 nm.
